(19) United States
(12) Patent Application Publication
(10) Pub. No.: US 2003/0001875 A1
(43) Pub. Date: Jan. 2, 2003

(54) Context-sensitive help for a Web-based user interface

(76) Inventors: Jason E. Black, Redmond, WA (US); John P. Brastad, Seattle, WA (US)

Correspondence Address: LEE & HAYES PLLC, 421 W RIVERSIDE AVENUE SUITE 500, SPOKANE, WA, 99201

(21) Appl. No.: 09/897,162

(22) Filed: Jun. 29, 2001

(51) Int. Cl. G09G 5/00

(52) U.S. Cl. 345/708

(57) ABSTRACT

The described subject matter provides context-sensitive help for a Web-based UI. A first and a second computer are operatively coupled to one-another over a network such as the Internet, an organizational intranet, or the like. The first computer communicates a Web-based UI to the second computer. The communicated Web-based UI includes a first Web page corresponding to a number of predetermined functions of the first computer. Responsive to receiving a request for help corresponding to the first Web page, the first computer, determines/identifies the first Web page's context sensitive information. The first computer generates a second Web page that includes the identified context-sensitive information, and communicates the second Web page to the second computer for display. In this manner, the first computer provides context-sensitive help for its remotely displayed Web-based UI.

### TECHNICAL FIELD

The described subject matter pertains to context sensitive help.

### BACKGROUND

A substantially important element of a user-friendly computer program application is readily available “help” information. Most computer programs provide some form of help information such as a help menu item in a main user interface (UI) window and/or context-sensitive help. Responsive to a user selecting a help menu item, an operating system (OS) typically sends a computer program a particular message indicating to the computer program that the user selected the menu item, causing at least one help window to be displayed. The displayed help window includes help information such as a list of help topics, an index, an introduction to the computer program, and/or the like.

To locate information corresponding to a user's help request (e.g., information to resolve a question, solve a perceived problem, etc.), the user must typically scroll through displayed help topics or an index, perform a keyword search, type in a natural language question, and/or the like. By doing this, the user leaves the context of the computer program within which the user is working to locate the help information in the displayed help window. After the user has read the displayed help, the user typically closes the help window to return to the computer program application within which the user was previously working.

A goal of context-sensitive help is to provide a user with help information without requiring the user to leave the context of the computer program within which the user is working. Responsive to a user action such as a right-button mouse click over a displayed UI object, context-sensitive help typically provides immediate context-sensitive information about the object without requiring the user to perform additional actions such as performing a keyword search in a separate window to locate desired information as described above. (Such UI objects can be any type of object such as a label, a control such as a button or a scroll bar in a property sheet or a dialog box, a window, and the like). The provided context-sensitive help generally answers context-sensitive questions with respect to the object of interest such as “What is this object?”, or “Why would I use this object?”

Conventional context-sensitive help implementations are limited in that a computer program that displays one or more UI objects, can not typically display context-sensitive help corresponding to the displayed objects unless the program was designed in advance to display context-sensitive help. This generally means that a software developer must have already mapped a respective unique ID to each UI object for which the program desires to provide such help. These unique IDs in turn must have already been mapped to one or more corresponding help files that include corresponding context-sensitive help information for the UI objects. Thus, a computer program generally cannot provide context-sensitive help for a UI that the program knows nothing about, regardless of whether the UI is being displayed, or rendered by the computer program.

To illustrate this, consider that a network-based product such as a server appliance communicates its Web-based UI (e.g., a number of HTML files that describe one or more Web pages) over a network for subsequent display by a different computer. In this example, the server appliance's UI allows a user to manage data storage devices such as respective disk drives and/or logical storage volumes. Responsive to receiving the server appliance's UI, a Web browser such as Microsoft Internet Explorer® that is executing on the different computer displays the communicated server appliance's Web page. In this example, the server appliance and the browser that is displaying the appliance's Web-based UI are executing on separate computers.

Unfortunately, unless the browser that is displaying the UI was pre-programmed to display context-sensitive help corresponding to specifics of the server appliance's Web-based UI, context-sensitive help is not generally available to a user viewing such a UI. This is because the browser rendering the Web-based UI does not know about the context of the server appliance's UI. The browser only knows about its own UI.

In this example, if a user that is viewing the server's UI does not know the difference between managing disks and volumes, the user will not generally be able to obtain any context-sensitive help to describe the difference. Instead, if the user selects a help menu item or help button displayed in the browser's UI, the user will be presented with help information that corresponds to the browser.

The following subject matter addresses these and other problems of traditional help implementations, which do not provide for the display of Web based-UI context-sensitive help.

### SUMMARY

The described subject matter provides context-sensitive help for a Web-based UI. A first and a second computer are operatively coupled to one-another over a network such as the Internet, an organizational intranet, or the like. The first computer communicates a Web-based UI to the second computer. The communicated Web-based UI includes a first Web page corresponding to a number of predetermined functions of the first computer.

Responsive to receiving a request for help corresponding to the first Web page, the first computer determines or identifies the first Web page's context sensitive information. The first computer generates a second Web page that includes the identified context-sensitive information, and communicates the second Web page to the second computer for display. In this manner, the first computer provides context-sensitive help for its remotely displayed Web-based UI.

### BRIEF DESCRIPTION OF THE DRAWINGS

FIG. 1 is a block diagram that shows an exemplary computing environment to provide context sensitive help for a Web-based UI.

FIG. 2 is a block diagram that shows an exemplary rendered Web page of a server appliance's Web-based UI. The rendered Web page provides a user of the server appliance with context-sensitive help corresponding to the appliance's Web-based UI.

FIG. 3 is a block diagram that shows a user interface of a Web browser that is executing on a different computer than a server appliance, wherein the Web browser renders an exemplary Web page of the server appliance's Web-based UI. The rendered Web page provides a user of the server appliance with context-sensitive help corresponding to the appliance's Web-based UI.

FIG. 4 is a block diagram that shows exemplary program modules and program data in a system to provide context-sensitive help for a server appliance's Web-based UI.

FIG. 5 is a flowchart diagram that shows an exemplary procedure to provide context-sensitive help for a Web-based UI.

### DETAILED DESCRIPTION

The following description sets forth a various implementations of the subject matter to provide context sensitive help for a Web-based user interface that incorporates elements recited in the appended claims. The various implementations are described with specificity to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Exemplary Operating Environment

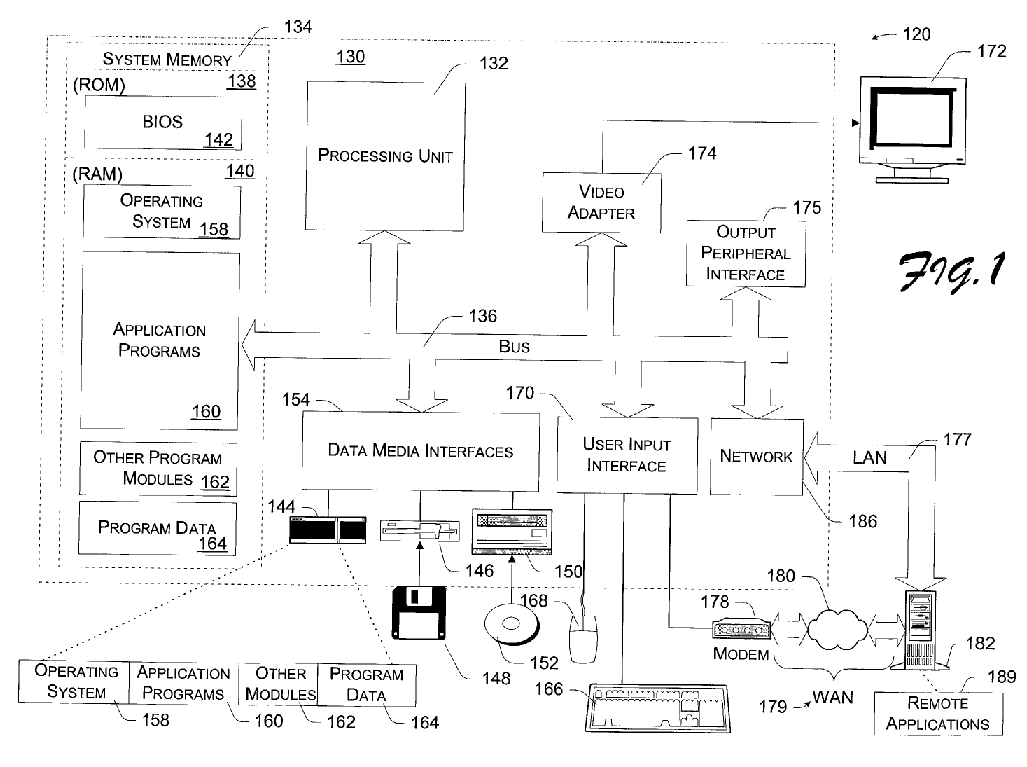

FIG. 1 illustrates an example of a suitable operating environment 120 in which an exemplary context sensitive help system for a Web-based UI may be implemented. Specifically, the context sensitive help system for a Web-based UI described herein is implemented (wholly or in part) by any program module 160-162 and/or operating system 158 in FIG. 1 or a portion thereof.

The operating environment 120 is only an example of a suitable operating environment and is not intended to suggest any limitation as to the scope or use of functionality of the exemplary context sensitive help system for a Web-based UI(s) described herein. Other well known computing systems, environments, and/or configurations that may be suitable for use with an exemplary context sensitive help system for a Web-based UI include, but are not limited to, server appliances, personal computers (PCs), server computers, hand-held or laptop devices, multiprocessor systems, microprocessor-based systems, programmable consumer electronics, wireless phones and equipment, general-purpose and special-purpose appliances, application-specific integrated circuits (ASICs), network PCs, minicomputers, mainframe computers, distributed computing environments that include any of the above systems or devices, and the like.

A context sensitive help system 120 for a Web-based UI may be described in the general context of computer-executable instructions, such as program modules, being executed by a computer. Generally, program modules include routines, programs, objects, components, data structures, etc. that perform particular tasks or implement particular abstract data types. An exemplary context sensitive help system for a Web-based UI may also be practiced in distributed computing environments where tasks are performed by remote processing devices that are linked through a communications network. In a distributed computing environment, program modules may be located in both local and remote computer storage media including memory storage devices.

As shown in FIG. 1, the computing environment 120 includes a general-purpose computing device in the form of a computer 130. In one implementation, the computing device 130 is a server appliance. A server appliance is a server does not require, for example, a monitor, a mouse or keyboard, and/or other interface peripherals. The server appliance may have one or more sets of well-defined functions such as a file server, an e-mail server, a data storage device, etc. The server appliance provides context-sensitive help for the appliance's Web-based UI.

The components of computer 130 may include, by are not limited to, one or more processors or processing units 132, a system memory 134, and a bus 136 that couples various system components including the system memory 134 to the processor 132. Bus 136 represents one or more of any of several types of bus structures, including a memory bus or memory controller, a peripheral bus, an accelerated graphics port, and a processor or local bus using any of a variety of bus architectures. Such architectures include, for example, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media. For example, the system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently be operated on by processor 132.

Computer 130 may further include other removable/non-removable, volatile/non-volatile computer storage media. By way of example only, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM, DVD-ROM or other optical media. The hard disk drive 144, magnetic disk drive 146, and optical disk drive 150 are each connected to bus 136 by one or more interfaces 154.

The drives and their associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 138, or RAM 140, including, by way of example, and not limitation, an operating system 158, one or more application programs 160, other program modules 162, and program data 164.

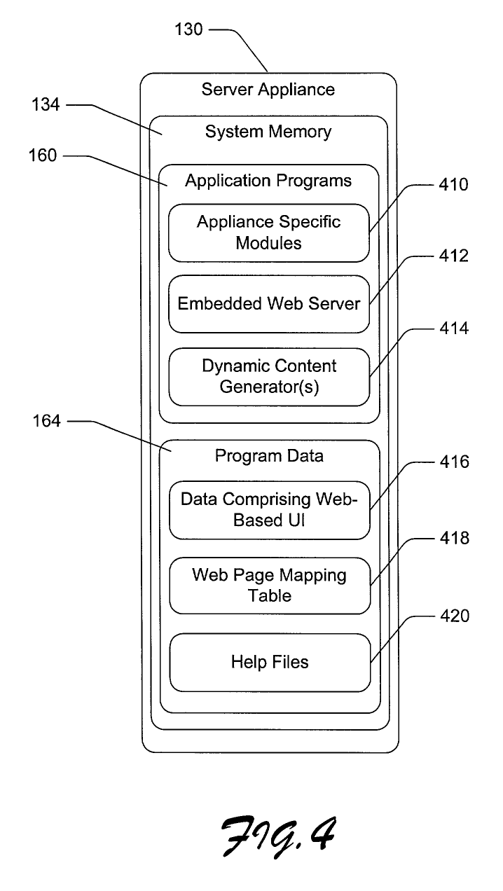

Each of such operating system 158, one or more application programs 160, other program modules 162, and program data 164 (or some combination thereof) may include an implementation of an exemplary context sensitive help system for a Web-based UI. More specifically, each may include an implementation of an embedded Web server program module for communicating a Web-based UI to another device over a network 186, one or more computer programs for dynamically generating a context-sensitive help for the communicated Web-based UI, a set of help files, and a table that maps unique context IDs that correspond to the Web-based UI to respective ones of the help files. (See, the application program modules 410 through 414 and the program data 416 through 420 of FIG. 4).

A user may enter commands and information into computer 130 through optional input devices such as keyboard 166 and pointing device 168 (such as a “mouse”). Other optional input devices (not shown) may include a microphone, joystick, game pad, satellite dish, serial port, scanner, or the like. These and other optional input devices are connected to the processing unit 132 through a user input interface 170 that is coupled to bus 136, but may be connected by other interface and bus structures, such as a parallel port, game port, or a universal serial bus (USB).

An optional monitor 172 or other type of display device may also be connected to bus 136 via an interface, such as a video adapter 174. In addition to the monitor, personal computers typically include other peripheral output devices (not shown), such as speakers and printers, which may be connected through output peripheral interface 175.

Computer 130 operates in a networked environment using logical connections to one or more remote computers, such as a remote computer 182. Remote computer 182 may include many or all of the elements and features described herein relative to computer 130. Logical connections include, for example, a local area network (LAN) 177 and a general wide area network (WAN) 179. Such networking environments are commonplace in offices, enterprise-wide computer networks, intranets, and the Internet.

When used in a LAN networking environment, the computer 130 is connected to LAN 177 via network interface or adapter 186. When used in a WAN networking environment, the computer typically includes a modem 178 or other means for establishing communications over the WAN 179. The modem 178, which may be internal or external, may be connected to the system bus 136 via the user input interface 170 or other appropriate mechanism.

Depicted in FIG. 1, is a specific implementation of a WAN via the Internet. Computer 130 typically includes a modem 178 or other means for establishing communications over the Internet 180. Modem 178, which may be internal or external, is connected to bus 136 via interface 170. The network connections shown and described are exemplary and other means of establishing a communications link between the computers may be used.

In a networked environment, program modules depicted relative to the personal computer 130, or portions thereof, may be stored in a remote memory storage device. By way of example, and not limitation, FIG. 1 illustrates remote application programs 189 as residing on a memory device of remote computer 182.

Computer-Executable Instructions

An implementation of an exemplary context sensitive help system for a Web-based UI may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer Readable Media

An implementation of an exemplary context sensitive help system for a Web-based UI may be stored on or transmitted across some form of computer readable media. Computer readable media can be any available media that can be accessed by a computer. By way of example, and not limitation, computer readable media may include “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Exemplary Server Appliance Web-Based UI

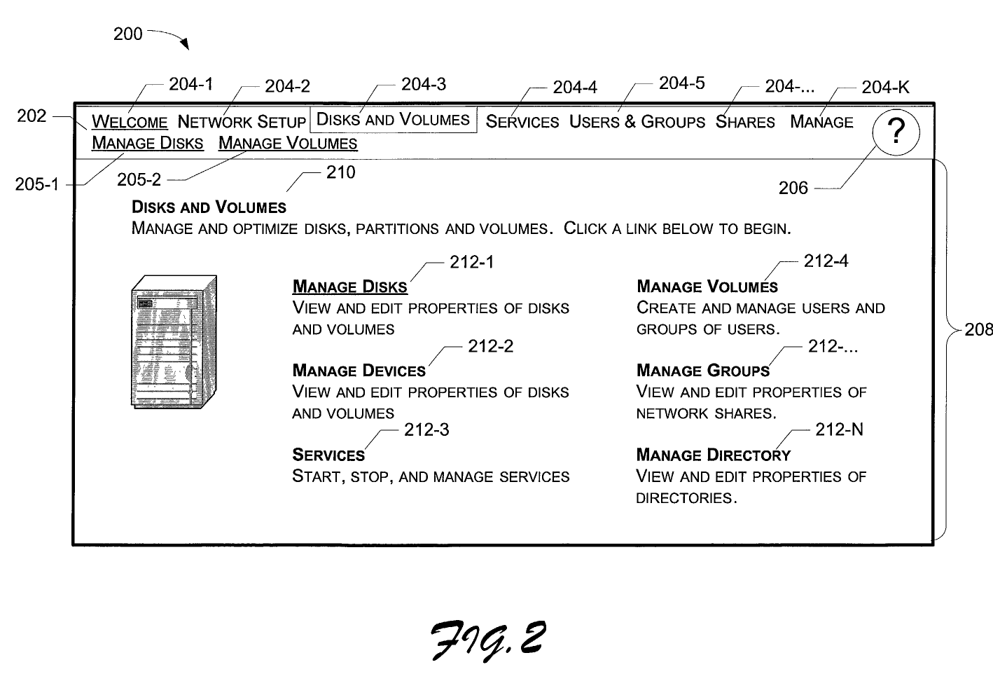

FIG. 2 is a block diagram that shows an exemplary server appliance's Web-based UI 200 to provide a user that is viewing the Web-based UI on a device other than the server appliance with context-sensitive help corresponding to the Web-based UI. Web page 200 may be only a portion of the Web-based UI. In other words, the Web-based UI may include any number of Web pages for presentation on a different computer than the server appliance computer. A user of the different computer interacts with the Web-based UI to remotely manage the server appliance, review information corresponding to the server appliance, and/or the like.

The types/functions of various server appliance implementations are virtually unlimited. Thus, depending on the function of a particular server appliance, the information and/or function provided by an appliance's Web-based UI will vary accordingly. However, for purposes of this example, the Web page 200 illustrates information and function of a server appliance that is used for managing a data storage device. The Web-based UI's Web page 200 provides a user with context-sensitive help corresponding to the Web page.

The Web page 200 includes a menu bar 202, menu items 204 and 205, a persistent help object 206, and a working area 208. The menu items provide a user with direct access to information and/or functionality that corresponds to a data storage device server appliance. Such menu items include hypertext links to direct a user to a particular Web page of the Web-based UI or function of the appliance with only a click of the mouse on either an image or word. Thus, the server appliance's framework determines both the look-and-feel of the Web page, as well as the appliance's response to user selection of a particular menu item.

Working area 208 presents information and functionality that corresponds to the server appliance. In this example, both because the server appliance is a data storage device and because the “Disks and Volumes” menu item 204-3 is selected (also note the presence of sub-menu items 205), the working area includes information corresponding to “Disks and Volumes”. This is further illustrated by the “Disks and Volumes” label 210 and various links 212. In this implementation the links are hypertext links that responsive to user selection request the appliance to: (a) present a different Web page of its remote UI; (b) perform a particular function; (c) and/or the like.

The persistent help object 206 provides access to context-sensitive help that is associated with the Web page 200. The help object can be any object such as a hypertext link, a bitmap image of question mark representation (as illustrated in this example), and the like. In this implementation, the persistent help object is displayed in the menu bar 202. However, the help object can be displayed anywhere in the Web page. The persistent object 206 is mapped to a Universal Resource Locator (URL) that identifies the network address of the server appliance that communicated the Web page 200 for display.

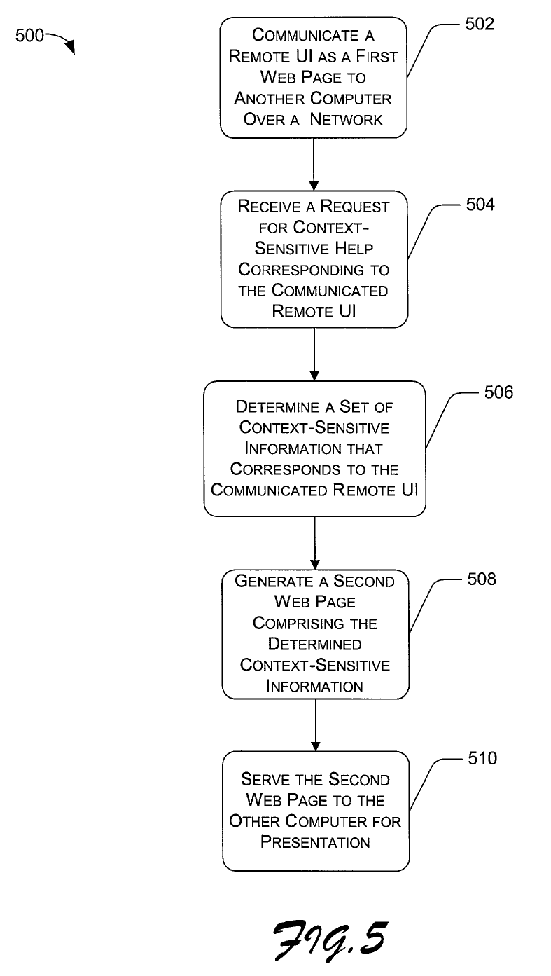

The URL behind the help object 206 further specifies a number of additional parameters such as the displayed Web page's 200 unique ID. Each Web page 200 of a server appliance's Web-based UI comprises a unique ID—meaning that a Web page's ID is unique with respect to all other Web page IDs within the appliance's UI framework. A Web page's unique ID is used to identify the Web page's corresponding context-sensitive help. (Systems, procedures, and data structures that use a unique ID to identify associated context sensitive help are discussed in greater detail below in reference to FIGS. 4 and 5.

A Web-based UI 200 can have many different features other than those described with respect to FIG. 2. For example, a different Web page 200 may include an audio presentation of a Web-based UI, wherein a user can select context-sensitive help corresponding to the Web page with an utterance that is recognizable by voice recognition software. Moreover, the different Web page may comprise one or more of a combination of aspects such as the menu bar 202, the work area 208, and/or the like.

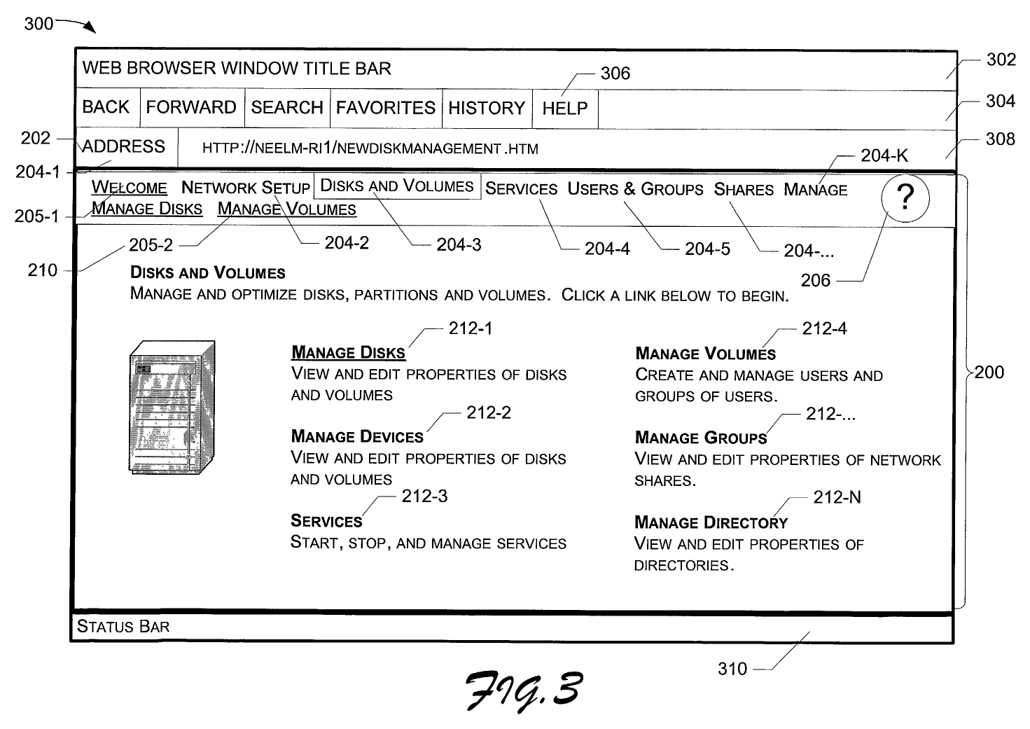

FIG. 3 is a block diagram that shows a Web browser 300 that is executing on a different computer than a server appliance. The Web browser has received the server appliance's Web-based UI such as the Web-based UI/Web page 200 of FIG. 2, and renders it. The rendered remote UI provides a user of the server appliance with context-sensitive help for the appliance's Web-based UI.

The browser 300 includes a title bar 302, a button bar 304, an address bar 308, a display region for rendering a Web page 200 of a server appliance's Web-based UI 200, and a status bar 310. The Web browser UI is typically customizable by a user to present one of a number of possible UIs portions. Thus, a Web browser may have more or less features than the features 302 through 310, as long as the Web browser can present a Web page such as the server appliance's Web-based UI.

The title bar 302 includes menu items such as a help menu item. (Individual menu items are not shown). The button bar 306 includes a number of buttons corresponding to the functionality of the Web browser 300 such as a help button 306. The address bar 408 provides a region to edit and display a text representation of a particular Web-site address such as a URL address.

In this example, a user has selected a “Disks and Volumes” Web page, which is part of a server appliance's remote, or Web-based UI 200 of FIG. 2. This is illustrated by a selected menu-item 204-3, label 210, and links 212, each of which is rendered in the browser's rendering area.

Exemplary System to Provide Context-Sensitive Help for a Web-Based UI

FIG. 4 is a block diagram that shows an exemplary portion of system memory 134 of a server appliance 130 of FIG. 1. Program Data 164 includes data 416 comprising the server appliance's Web-based UI. Such data includes data for one or more Web pages such as Web Page 200 of FIG. 2. The program data also comprises one or more Web page mapping tables 416 and an optional set of help files 418.

A Web page mapping table 418, maps unique IDs to respective Web Pages of the remote, or Web based UI of the server appliance. The server appliance utilizes a Web page's unique ID to identify the Web page's corresponding context-sensitive help information To accomplish this, a Web page's unique ID identifies either: (a) one or more specific help files such one or more specific Hypertext Markup Language (HTML) files that contain the Web page's particular context sensitive help topic(s); or, (b) other information that is used to identify a help data source.

In one implementation, a help data source includes, for example, a URL that identifies a networked device that stores help data. Because it is not necessary for help data to be hardwired into the mapping table 418, a referenced help data source can be modified, moved to a different location, and/or renamed as necessary. Moreover, because the mapping table can be used to map a source of help information to a device other than a server appliance 130, original equipment manufacturers (OEMs) and/or independent hardware vendors (IHVs) of the server appliance are not required to take up the server appliance's limited memory resources to help data.

In one implementation, the mapping table 418 identifies a default set of help data. If the default set of help data is not accessible, the table identifies alternative help data and/or one or more alternative help data sources.

The help files 420 include context sensitive help information corresponding to one or more Web pages of the server appliance's 130 Web-based UI. As discussed above, it is not necessary for the help files to be stored on the server appliance.

The application programs 160 include server appliance specific modules 410, embedded Web server 412, and dynamic content generator(s) 414. The appliance specific modules comprise one or more computer program applications to perform the single function or set of well-defined functions of the appliance.

The embedded web server 414 both communicates a Web page to one or more other computers on a network and receives requests from the one or more computers on the network. (Procedures to use an embedded Web server to communicate, or “serve” a Web page and to receive requests from other computers are well-known to those skilled in the arts of computer programming and network software). Specifically, the embedded Web server communicates the server appliance's 130 data comprising a Web-based UI 416 to another computer. Requests for context-sensitive help corresponding to respective Web pages in the appliance's Web-based UI are received at one or more predetermined Universal Resource Locators (URLs).

The dynamic content generator program module(s) 414 comprises one or more computer programs that implement a server-side scripting interface to generate dynamic content including context-sensitive help for the server appliance's 130 Web-based UI. Such server-side scripting interfaces include, for example, Common Gateway Interface (CGI) and an Internet Server Application Program Interface (ISAPI), both of which are well known to those skilled in the art of computer programming. CGI is a broad category that includes all possible programming models that can be used to implement server-side scripting, including all computer program languages that can be used to generate computer-executable instructions.

To dynamically generate context-sensitive help for a particular Web page, a dynamic content generator 414 performs one or more of a combination of: (a) identifying a source of the particular Web page's corresponding help information; (b) retrieving the help information from the identified source; (c) performing any modifications to the retrieved help such that it will be compatible with one or more platforms of a computer (e.g., an operating system or a Web browser platform, a preferred language such as English or French, etc.) that sent the request for the context-sensitive help; and (d) performing any other modifications to the retrieved help based on other criteria (if any) that may effect the type and/level of context sensitive help that will be presented to a user. Such other criteria may be based on the intended use of the computer, based on predetermined user preferences, etc.

For example, a server appliance intended for use in a residential setting may also use predetermined preferences of users (e.g., a user's age) to generate the appropriate help content for the user.

To modify help information to be compatible with a particular platform of a computer that is going to present the appliance's Web based UI, a set of parameter information is mapped to a URL that in turn is mapped to the persistent help object 206 of FIG. 2. Such parameter information includes, for example: (a) a hardware platform indication; (b) an operating system indication such as Microsoft WINDOWS®, Linux, and the like; (c) a Web browser type indication such as a Microsoft Internet Explorer®, Netscape Navigator®, and the like; (d) software version information; or (e) a preferred language.

For example, if a particular Web browser does not display HTML, dynamic content generator program 414 converts the identified help information into some other preferred presentation format such as speech output. The server appliance may be coupled to various help files language sets such as English help files, Japanese help files, French help files, etc. The referenced program knows which language is being used on the computer that is presenting a server appliance's Web-based UI, and determines the correct help file to present to a user.

In one implementation, the dynamic content generator program modules are modules within the embedded web server 412.

Exemplary Procedure to Provide Context-Sensitive Help for a Web-Based UI

FIG. 5 is a flowchart diagram that shows an exemplary procedure 500 to provide context-sensitive help for a server appliance's Web-based UI. At block 502, a server appliance communicates a Web page of a Web-based UI to a different computer that is coupled to the server appliance over a network. At block 504, the server appliance receives a request for context-sensitive help from the different computer that corresponds to the communicated Web-based UI (block 502). Such a request is made by user selection of a help object 206 of FIG. 2. (In this implementation, the help object is mapped to a URL that identifies a network address of the server appliance).

At block 506, responsive to receiving the request for context-sensitive help (block 504), the server appliance determines context sensitive information corresponding to the communicated Web-based UI (block 502). At block 508, the procedure generates a Web page that includes the determined context-sensitive help information (block 506). At block 510, the server appliance communicates the context-sensitive help as another Web page to the different computer.

Thus, in contrast to conventional Web-based UIs, which do not provide context sensitive help to a user, procedure 500 provides context-sensitive help for a Web-based UI, regardless of which type of computer, OS, Web browser, or language is used by a computer when presenting the Web-based UI.

Although details of various implementations are described above, such details are intended to satisfy statutory disclosure obligations rather than to limit the scope of the following claims. Thus, the subject matter as defined by the claims is not limited to the specific features described above. Rather, the subject matter is claimed in any of its forms or modifications that fall within the proper scope of the appended claims, appropriately interpreted in accordance with the doctrine of equivalents.

1. Method for providing context-sensitive help from a first computer to a second computer for a Web-based user interface (UI) of the first computer, the method comprising:
receiving a request for context sensitive help at the first computer from the second computer, the request corresponding to a first Web page of a Web-based UI of the first computer;
responsive to receiving the request, the first computer:
determining a set of context sensitive information that corresponds to the first Web page;
generating a second Web page comprising the context sensitive information; and
providing the second Web page to the second computer for presentation.

2. A method as recited in claim 1, wherein the first computer is a server appliance.

3. A method as recited in claim 1, wherein generating the second Web page further comprises:
generating the second Web page in a format that is compatible with a platform of the second computer, the platform comprising a hardware platform, an operating system platform, a Web browser type indication, a software version indication, a preferred language indication, an intended use of the second computer, and/or predetermined preferences of a user.

4. A method as recited in claim 1, before receiving the request, further comprising:
communicating, by the first computer, a Web-based UI to the second computer, the first computer being operatively coupled over a network to the second computer, the Web-based UI comprising a first Web page corresponding to one or more predetermined functions of the first computer.

5. A method as recited in claim 1, further comprising:
responsive to determining the context sensitive help information, retrieving the context sensitive help information from one or more help files.

6. A method as recited in claim 1, before receiving the request, further comprising:
communicating, by the first computer, a Web-based UI to the second computer, the first computer being operatively coupled over a network to the second computer, the Web-based UI comprising a first Web page corresponding to one or more predetermined functions of the first computer, the first Web page comprising a unique ID and a persistent help object that is mapped to a URL of the first computer, the URL comprising the unique ID; and
wherein determining the context sensitive help information is based on the unique ID.

7. A method as recited in claim 6:
wherein the URL further comprises a reference to one or more computer programs on the first computer; and
wherein the operations of determining the context-sensitive help and retrieving the context sensitive help are performed by the one or more computer programs that use a server-side scripting interface.

8. A method as recited in claim 6:
wherein the URL further comprises a reference to one or more computer programs on the first computer; and
wherein the operations of determining the context sensitive help and retrieving the context sensitive help are performed by the one or more computer programs using a server-side scripting interface that generates dynamic content.

9. A computer readable medium comprising computer-executable instructions for performing a method as recited in claim 1.

10. A computer-readable storage medium comprising one or more program modules for providing context-sensitive help for a Web-based user interface (UI) of a first computer to a second computer, wherein the one or more program modules comprise computer-executable instructions for:
receiving a request for a set of context sensitive help corresponding to a Web-based UI of the first computer, the request being received at the first computer, the Web-based UI corresponding to one or more functions of the first computer, the Web-based UI being presented on the second computer, the first computer being operatively coupled to the second computer over a network; and
responsive to receiving the request, the first computer:
generating a second Web page comprising the context-sensitive help; and
communicating the second Web page to the second computer for presentation.

11. A computer readable storage medium as recited in claim 10, wherein the first computer is a server appliance.

12. A computer-readable storage medium as recited in claim 10, wherein generating the second Web page further comprises instructions for:
generating the second Web page to be compatible with a platform of the second computer, the platform being comprising an operating system platform, a Web browser platform, a preferred language, an intended use of the second computer, and/or predetermined preferences of a user.

13. A computer-readable storage medium as recited in claim 10, wherein the computer-executable instructions further comprise instructions for:
communicating, by the first computer, the Web-based UI to the second computer, the first Web-based UI comprising a persistent object mapped to a set of context-sensitive help that corresponds to the one or more functions.

14. A computer-readable storage medium as recited in claim 10, wherein the computer-executable instructions for generating the second Web page further comprise instructions for retrieving the context sensitive help from one or more help files.

15. A computer-readable storage medium as recited in claim 10, wherein the computer-executable instructions further comprise instructions for:
communicating, by the first computer, the first Web-based UI to the second computer, the first Web-based UI comprising a persistent object mapped a set of parameters comprising a set of context-sensitive help corresponding to the one or more functions, a URL of the first computer, and a unique ID corresponding to the first Web-based UI; and
wherein the computer-executable instructions for receiving the request further comprise instructions for:
receiving the request at the URL, the request comprising the unique ID; and
wherein the computer-executable instructions for generating the second Web page further comprise instructions for:
identifying the context sensitive help based on the unique ID.

16. A computer-readable storage medium as recited in claim 10, wherein the first Web page further comprises a reference to one or more computer programs on the first computer; and wherein the computer-executable instructions for generating the second Web page further comprises instructions for:
generating the second Web page with a server-side scripting interface for generating dynamic content that is identified by the one or more computer programs.

17. A computer-readable storage medium as recited in claim 10, wherein the first Web page further comprises a reference to one or more computer programs on the first computer; and wherein the computer-executable instructions for generating the second Web page further comprises instructions for:
generating the second Web page with a server-side scripting interface for generating dynamic content that is identified by the one or more computer programs.

18. A computer comprising a processor that is operatively coupled to one or more computer-readable storage media as recited in claim 10, the processor being configured to execute the computer program instructions.

19. A system for providing context-sensitive help for a Web-based user interface (UI), the system comprising:
a memory comprising a set of computer-executable instructions; and
a processor coupled to the memory, the processor being configured to execute the computer executable instructions for:
communicating the Web based UI to a different system for presentation;
responsive to receiving a request for context sensitive help, determining a set of context-sensitive help that corresponds to the Web-based UI; and
communicating the context-sensitive help to the different system for presentation.

20. A system as recited in claim 19, wherein the Web-based UI further comprises a persistent help object that is programmed, responsive to user selection, to communicate a context-sensitive help request message to the system.

21. A system as recited in claim 19, wherein the Web-based UI further a persistent help object that is programmed to send, upon selection, a context-sensitive help request message to a URL that identifies the system.

22. A system as recited in claim 19, wherein the Web-based UI further comprises a persistent help object that is programmed, responsive to user selection, to communicate a context-sensitive help request message to the system, the context-sensitive help request message comprising a unique ID corresponding to the Web-based UI,, and wherein the computer-executable instructions for determining further comprise instructions for:
identifying the context-sensitive help based on the unique ID.

23. A system as recited in claim 19, wherein the computer-executable instructions for determining further comprise a server-side scripting interface for returning dynamic content to the system and wherein the context-sensitive help is dynamic content.

24. A system as recited in claim 23, wherein the server-side scripting interface is selected from a set of scripting interfaces comprising a Common Gateway Interface and/or an Internet Server Application Program Interface.

25. A system as recited in claim 19, wherein the computer-executable instructions further comprise instructions for:
encapsulating the context sensitive help into a Web page that is compatible with a platform of the computer selected from a combination of platforms comprising an operating system, a Web browser, and/or a language; and
wherein the computer-executable instructions for communicating further comprise instructions for:
communicating the context sensitive help embedded in the Web page.

26. A user interface embodied in a computer-readable storage medium for providing context-sensitive help for a remote user interface (UI), the user interface comprising:
a first area for displaying, on a first device, a remote UI that corresponds to a second device; and
a second area within the first area for providing a context-sensitive help control for accessing a set of context sensitive help that corresponds to the remote user interface.

27. A user interface as recited in claim 26, wherein the context-sensitive help control is a representation of a question mark.

28. A user interface as recited in claim 26, wherein the context-sensitive help control is mapped to a URL that comprises a unique ID that corresponds to a particular Web page of the Web-based UI, the unique ID referencing the context-sensitive help.

29. A user interface as recited in claim 26, wherein the context-sensitive help control is mapped to a URL comprising a reference to a computer program module and one or more parameters for the computer program module, the one or more parameters being a combination of parameters comprising a unique ID corresponding to the Web-based UI, an operating system, a Web browser, a software version indication, and/or a language, the computer program module and the one or more parameters being used by the second device to identify, retrieve, and/or modify the context-sensitive help.

30. A user interface as recited in claim 26, wherein the second device is a server appliance.

31. A computer comprising a processor that is operatively coupled to a memory comprising computer-executable instructions for displaying a user interface as recited in claim 26.
